(19) United States
(12) Patent Application Publication
(10) Pub. No.: US 2021/0394222 A1
(43) Pub. Date: Dec. 23, 2021

(54) UNITIZED VALVE SEAT ASSEMBLY

(71) Applicant: Craftech, Inc., Elk Grove Village, IL (US)

(72) Inventors: Jeffrey C. ROBERTS, Elgin, IL (US); Jeffrey L. TAYLOR, Schaumburg, IL (US)

(21) Appl. No.: 17/275,634

(22) PCT Filed: Sep. 6, 2019
(86) PCT No.: PCT/US2019/049997

§ 371 Date: Mar. 11, 2021

Related U.S. Application Data
(60) Provisional application No. 62/734,801, filed on Sep. 21, 2018.

(51) Int. Cl. B05B 15/18; F02M 61/16; F02M 61/18; B05B 1/30; B05C 5/02

(52) U.S. Cl. CPC B05B 15/18; F02M 61/166; F02M 61/1886; B05B 1/3046; F05C 2251/10; F02M 61/168; F05C 2201/0412; F05C 2203/0817; F05C 2211/00; B05C 5/0225

(57) ABSTRACT

A valve seat assembly including a housing having a cavity and a puck located in the cavity and connected to the housing. The puck having a greater hardness than the housing.

The present application claims the benefit and priority of U.S. Provisional Application No. 62/734,801, filed Sep. 21, 2018, which is hereby incorporated herein by reference.

### FIELD OF THE DEVICE

The present disclosure relates valve seat assemblies that may be used in dispensing apparatuses, and valve seat assemblies that define nozzles for dispensing a liquid. More particularly, the present disclosure relates to wear resistant valve seat assemblies.

### BACKGROUND

Microdispensing is a process in which very small amounts of liquid are dispensed from a nozzle. This process may be used in any number of applications, including but not limited to, dispensing adhesives, solvents and inks or dispensing materials in 3D printing processes. Microdispensing may include the use of a nozzle that includes a valve seat at the top of the nozzle and a dispensing orifice at the bottom of the nozzle. A valve element engages with and separates from the valve seat at the top of the nozzle to control the dosing of liquid that flows through the nozzle. For example, the valve element and valve seat have mating points that produces a seal and prevents the flow of fluid through the nozzle. When the valve element is actuated to be pulled back from the mating point, fluid travels around the valve element, through the a channel and out the orifice. When the valve element is actuated to re-engage the valve seat the fluid flow through the nozzle stops.

The actuation of the valve element occurs extremely quickly and, in some instances, billions of actuations can occur in a very short period of time. With all of the actuations, the valve seat of the nozzle can wear very quickly. In addition to wearing from contact with the valve element, when the fluid being processed is abrasive, it is possible for the fluid to leave a residue on the components. This residue can become lodged into the nozzle during actuation. This lodging of abrasive particles speeds up the degradation of the material, which translate to the failure of the components.

The wearing of the valve seat results in the components requiring change out. Change-out results in the machine employing these components being down and end product not being produced. In addition, the nozzle components can be very small in size, resulting in difficultly in changing out the nozzle when wear occurs.

In order to reduce wear of the material, it would be desirable to use nozzles that are made with materials having a greater hardness, which have a greater resistance to wearing. However, although materials with a greater hardness have better resistance properties, such materials also are typically very brittle, and thus, are prone to cracking and chipping. It is under desirable to use materials that are prone to cracking and chipping when put under repeated pressure because such material would also be required to be changed out frequently.

There for there remains a need for parts that are wear resistant and are not prone to cracking or chipping.

### BRIEF DESCRIPTION OF THE DRAWINGS

FIG. 1 is a cross-sectional view of one embodiment of a valve assembly in accordance with the present disclosure.

FIG. 2 is an enlarged cross-sectional view of the valve assembly.

FIG. 3 is a perspective view of one embodiment of a puck in accordance with the present disclosure.

FIG. 4 is a cross-sectional view of the puck shown in FIG. 3.

FIG. 5 is a perspective cross-sectional view of the puck of FIG. 3 shown engaged with a valve element.

### DESCRIPTION OF THE PREFERRED EMBODIMENT

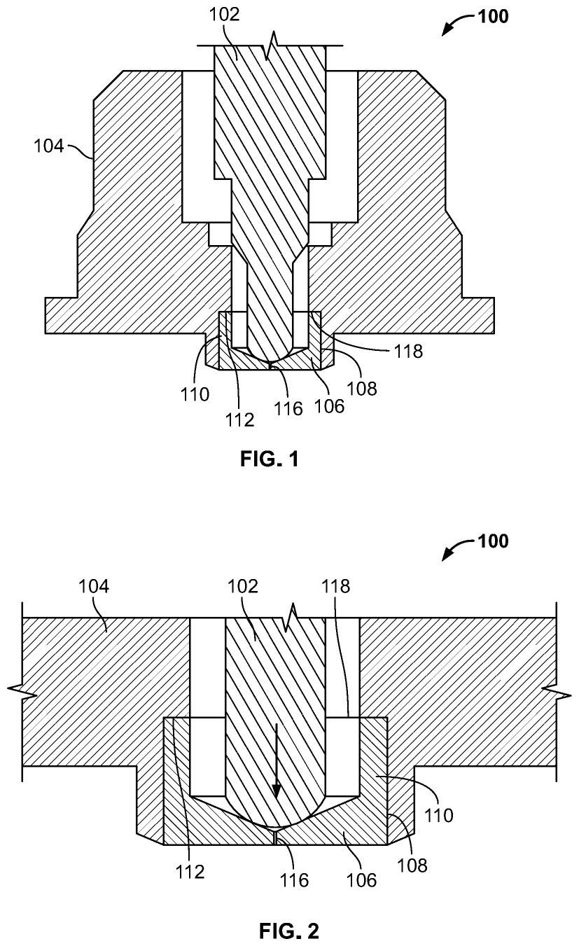

Turning now to the figures, FIG. 1 illustrates one embodiment of a valve seat assembly 100 that is shown with a valve element 102. The valve seat assembly 100 may be used in a variety of different apparatuses and machinery. For example, the valve seat assembly may be part of a microdispensing apparatus that is used for dispensing very small amounts of oil, adhesive, liquid or any other media. The valve seat assembly may be used in applications, such as printing and 3-D printing or circuit board assembly, among others.

The valve seat assembly 100 includes a housing 104 and a puck 106 that are made from different material and are connected to each other. The housing 104 includes a cavity 108 that receives or contains the puck 106. Preferably, the housing 104 and puck 106 are permanently affixed to one another so as to form a unitized one-piece assembly. The housing 104 may be of any number of shapes and sizes, and the shape and size of the housing may vary depending on the type of apparatus in which the valve seat is incorporated. The housing 104 also may be made of a material that has a hardness (kg/mm²) that is less than that of the material of the puck 106. The material of the housing may be for example, Tungsten Carbide, Hardened Tool Steel, Aluminum, etc.

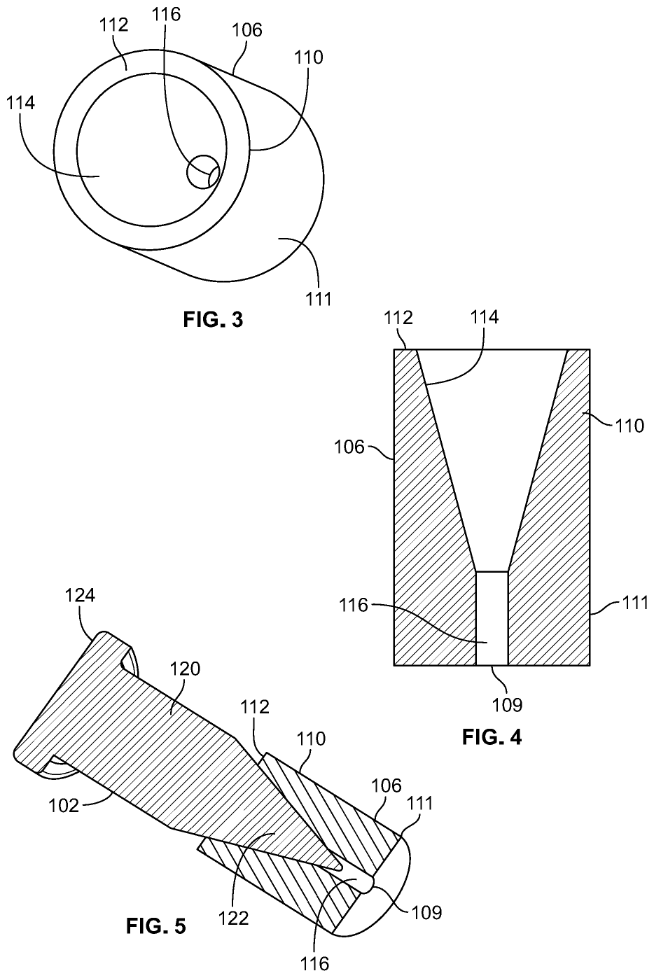

Referring to FIGS. 3 and 4, the illustrated puck 106 includes a cylindrical or generally cylindrical body. In other embodiments, the body may have other geometrical shapes or non-geometrical shapes. The puck also may have a height H of between about 0.05 inches and about 0.5 inches and a cross-sectional width W of between about 0.1 inches and about 0.5 inches. When the puck has a cylindrical shape, the cross-sectional width is a diameter. In one embodiment the height of the puck may be less than or equal to about 0.125 inches (3.18 mm) and the cross-sectional width may be less than or equal to about 0.125 inches (3.18 mm). In the illustrated embodiment, the top portion 110 of the puck may include a rim 112 and, optionally, may define a funnel shaped portion 114. The funnel shaped portion 114 may be any shape that progressively slopes inward toward the center of the puck 106. In the illustrate embodiment, the funnel shaped portion 114 may be cone shaped. In one embodiment, the cone shape may be a truncated cone shape. The height and diameter of the cone shape may vary depending on the desired application. As shown in FIGS. 1, 2 and 4, the top portion 114 of puck 106 defines a valve seat that engages with valve element 102. Additionally, the surface of the funnel shaped portion 114 may be smoothed or textured. For example, the surface may include rings, ridges, bumps or other textures.

When the puck 106 defines a nozzle for dispensing a material, the puck 106 also may include a channel 116 therethrough for dispensing the material, such as any of the liquids mentioned above. The channel 116 may have an opening 109 in the bottom portion 111 of the puck. The channel may have an opening or a diameter that is between about 0.0005 inches and about 0.080 inches. In one embodiment, the opening of the channel may be about 0.012 inches.

The puck 106 may be made from a material having a hardness greater than that of the housing 104. In one embodiment, the material of the puck 106 may have a Vickers hardness that is greater than or equal to about 2,800 kg/mm². In other embodiments, the Vickers hardness of the material may be greater than or equal to about 3,000 kg/mm², or greater than or equal to about 4,000 kg/mm². In one embodiment, the material of the puck 106 may include silicon carbide. In other embodiments, the material of the puck 106 may include a diamond material. For example the diamond material of the puck 106 may be in an amount that is greater than 79% vol, or may be in an amount the is greater than 85% vol, or may be in an amount that is between 85% vol and 95% vol. The diamond material may be, for example, a ceramic diamond material, a polycrystalline diamond material or any other suitable diamond material. Furthermore, the material of the puck 106 may be a composite including the diamond material and a binder. Such binders may include cobalt, silicon carbide and other suitable binder material. The binder may allow for the material to possess a relative conductivity so that it may be machined using electronic discharge machining processes. This processing and other processing may be employed to form the finished features of the puck that allow for fluid flow through the nozzle. Furthermore in addition to wear resistance, diamond material has a low coefficient of friction, which may assist in preventing the materials being dispensed from sticking to the puck 106.

The puck 106 may be connected to the housing 104 by bonding. Preferably, the bonding permanently affixes the housing 104 and puck 106 to one another so as to form a unitized one-piece assembly. The bonding may be, for example, brazing. In one embodiment, the brazing may be alloy brazing. The alloy brazing may contain elements of titanium, silver, nickel, aluminum, indium, tin, and/or copper. The puck and housing may be connected in other manners as well, such as by epoxy, shrink-fit, press-fit, mechanical. Referring to FIGS. 1 and 2, the puck 106 may be connected to the housing 104 along rim 112. For example, the puck may be connected to the by a brazed joint 118 between the housing 104 and the rim 112. Alternatively or in addition to connecting the puck to the housing at the puck's rim, the puck may be connected to the housing at any point along body of the puck.

As mentioned above, the material of the puck 106 may have a greater hardness than the material of the housing 104. Furthermore, the material of the housing 104 may have a fracture toughness that is greater than the material of the puck 106, based on ASTM E1820-18. In one embodiment, the housing material, coupled with the bonding medium, places the diamond material of the puck 106 into compression and generates a shock absorption mechanism around the diamond material. With the puck 106 and the housing 104 acting as a unitized, single entity, the toughness of the housing and the bonding mechanism create a system that allows for the diamond-like material to absorb the impact during use with a reduced risk of fracture and chipping of the puck material. Furthermore, the housing 104 allows the capture of the puck 106 in a way for the assembly to be easily handled. For example, the assembly can be transitioned through manufacturing operations to end use with minimized risk to chipping.

Referring to FIGS. 1, 2 and 4, in one application, the puck 106 may define a nozzle to microdispense fluids. In a closed position, the valve element 102 seats or engages the top funnel shaped portion 114 of the puck 106 to close off channel 116. The valve element 102 may have a segment that has a shape and size that is commensurate or corresponds to the shape and size of the funnel shaped portion 114 or the valve seat. In the illustrated embodiment, valve element 102 includes a body having a top portion 120 and a bottom portion 122. The top portion 120 may be any shape, such as cylindrical. In the illustrated embodiment, the top portion 120 includes a flange 124 that may be used to connect the valve element to the apparatus. The bottom portion 122 defines a closing member that mates with the top portion 114 of the puck 106 to close channel 116 of the puck. The bottom portion 122 of the valve element 102 defines a cone shape that has a size commensurate with the funnel shaped portion 114 of puck 106. To close the channel 116 of the puck 106, the bottom portion 122 of the valve member 102 is inserted into and/or mated with the funnel portion/valve seat of the puck 106.

To dispense material, the valve element 102 is actuated to move upward in the figures and disengage from the top funnel shaped portion 114 of the puck 106. This allows material to travel through channel 116 for dispensing. The valve element 102 is then actuated to move downward in the figures to mate or engage with the top funnel shaped portion 114 of the puck 106 to close off the channel 116. In some applications and apparatus, the actuation of the valve member 102 occurs extremely quickly and billions of actuations may take place in a very short period of time. Thus, the valve element 102 may disengage and engage the puck 106 numerous times in a very short period. As described above, the puck 106 and housing 104 being connected allows for the force associated with actuation of the valve element 102 on the puck 106 to be minimized, reducing the risk of a brittle fracture of the diamond material of puck 106.

In addition, minimized friction results in reduced surface tension allowing for a more consistent droplet to be produced from the orifice exit. The puck 106 may be made from a material having a coefficient of friction less than that of the housing 104. In one embodiment, the material of the puck 106 may have a coefficient of static and kinetic friction that is less than or equal to about 0.2, based on ASTM G115-10 (2018). In other embodiments may be less then 0.15, or less than or equal to about 0.1.

Having thus described the device, various modifications and alterations will occur to those skilled in the art, which modifications and alterations will be within the scope of the device as defined by the appended claims.

What is claimed is:

1. A valve seat assembly comprising:
a housing having a cavity; and
a puck located in the cavity and being connected to the housing, the puck being made from a material that has a hardness that greater than or is equal to 2,800 kg/mm² and the housing being made from a material having a hardness less than the material of the puck.

2. The valve seat assembly of claim 1, wherein the puck is permanently affixed to the housing.

3. The valve seat assembly of claim 2, wherein the puck is permanently affixed to the housing by brazing.

4. The valve seat assembly of claim 2, wherein the puck is permanently affixed to the housing by titanium alloy brazing.

5. The valve seat assembly of claim 1, wherein the material of puck comprises silicon carbide.

6. The valve seat assembly of claim 1, wherein the puck has a hardness that is greater than or equal to 3000 kg/mm².

7. The valve seat assembly of claim 1, wherein the material of the puck comprises a diamond material.

8. The valve seat assembly of claim 7, wherein an amount of diamond material in the puck is greater than 79% vol.

9. The valve seat assembly of claim 7, wherein the material of the puck is a composite including the diamond material and a binder.

10. The valve seat assembly of claim 7, wherein the diamond material comprises ceramic diamond.

11. The valve seat assembly claim 7, wherein the diamond material is a polycrystalline diamond.

12. The valve seat assembly of claim 1, wherein the puck defines a nozzle having a dispensing channel therethrough.

13. The valve seat assembly of claim 12, wherein the dispensing channel has an orifice that is less than or equal to 0.012 inches (0.3 mm).

14. The valve seat assembly of claim 1, wherein the puck has a height that is less than or equal to 0.125 inches (3.18 mm) and cross-sectional width that is less than or equal to 0.125 inches (3.18 mm).

15. The valve seat assembly of claim 1, wherein the puck includes a top portion that defines a funnel.

16. The valve seat assembly of claim 1, wherein the puck includes a top portion that forms a valve seat configured for mating with valve element.

17. The valve seat assembly of claim 1, wherein the housing has a greater fracture toughness than the puck.

18. The valve seat assembly of claim 1, wherein the puck has a lower coefficient of friction than the housing.

19. The valve seat assembly of claim 1, wherein a material of the puck has a coefficient of friction that is less than 0.2.

20. A microdispensing apparatus for dispensing fluids, comprising
a valve seat assembly having a housing having a cavity, and a puck located in the cavity and being connected to the housing, the puck being made from a material that has a hardness that greater than or is equal to 2,800 kg/mm2 and the housing being made from a material having a hardness less than the material of the puck, the puck having a channel for dispensing fluids; and
valve element that actuates to open and close the channel.
